(19) United States
(12) Patent Application Publication
(10) Pub. No.: US 2004/0163483 A1
(43) Pub. Date: Aug. 26, 2004

(54) Windscreen wiper device, in particular for a motor vehicle

(76) Inventor: Achim Hawighorst, Buhlertal (DE)

Correspondence Address: MICHAEL BEST & FRIEDRICH, LLP, 100 E WISCONSIN AVENUE, MILWAUKEE, WI, 53202, US

(21) Appl. No.: 10/481,842

(22) PCT Filed: Jul. 2, 2002
(86) PCT No.: PCT/DE02/02399

(30) Foreign Application Priority Data
Nov. 7, 2001 (DE) 101 54 640.8

(51) Int. Cl. F16H 21/18

(52) U.S. Cl. 74/42

(57) ABSTRACT

A windshield wiper apparatus is proposed, in particular for a motor vehicle, with a drive unit (16) that features an output shaft (22), which is connected to a crank (24) in a torque-proof manner, whereby the connection of the crank (24) to the output shaft (22) is embodied as an integral connection, in particular as a laser weld connection.

### STATE OF THE ART

The invention relates to a windshield wiper apparatus in accordance with the species of the independent claim.

Numerous windshield wiper apparatuses are already known which feature a drive unit with an output shaft that is connected to a crank in a torque-proof manner. In the case of these apparatuses, the armature shaft of an electric motor is provided with a worm that meshes with a toothed wheel, which drives an output shaft, which is connected on one end via a cone and a fastening nut to a motor crank in a torque-proof manner. In this case, the toothed wheel is arranged in a housing, which is penetrated by the output shaft. An eccentric bushing is inserted in the gearbox housing for positioning purposes and the output shaft is inserted through this bushing and can be displaced laterally through it.

The output shaft itself has a cone in the end facing away from the gearbox housing, which is terminated by a thread. A crank is placed on the cone and fastened with a fastening nut. In order to limit the axial play of the output shaft, the output shaft features grooves in the area between the cone and the eccentric bushing so that a speed nut arranged on the eccentric bushing inhibits the axial play of the output shaft.

### ADVANTAGES OF THE INVENTION

The windshield wiper apparatus with the features of the main claim has the advantage that the output shaft is connected to a crank in a torque-proof manner and the connection of the crank to the output shaft is realized as an integral connection, something which produces a stable connection between the crank and output shaft, which can also be realized cost effectively since several work steps, such as, e.g., cutting threads, screwing on a fastening nut, undercutting a cone, can be eliminated. A laser weld connection in particular is offered for this purpose.

Advantageous further developments and improvements of the features indicated in the main claim are yielded by the measures listed in the sub-claims.

It is particularly advantageous if the output shaft penetrates the complete thickness of the crank and features an end face, which essentially terminates flush with an outer surface of the crank that faces away from the drive unit. In this way, the required construction space for the output shaft/crank combination is minimized, on the one hand, and, on the other hand, the laser welding can be realized easily starting from the side facing away from the drive unit. In addition, the largest possible bearing surface between the crank and the output shaft can be advantageously realized, thereby producing a secure laser weld connection.

It is should be viewed as particularly advantageous if the output shaft projects out of a housing and at least one spacer piece is arranged between the crank and the housing in order to limit the axial play of the output shaft.

In this connection, it is particularly advantageous if the output shaft is positioned on the housing in a bushing. The spacer piece is then supported in an advantageous manner on the bushing and on the crank.

In addition, it is advantageous if the bushing is embodied as an eccentric bushing in order to adjust the lateral position of the output shaft, which is driven by a worm wheel meshing with a worm, in an assembled stated in a simple manner.

Moreover, it is particularly advantageous if the spacer piece is connected to the output shaft in a torque-proof manner so that uncontrolled movement of the spacer piece as well as increased wear of the bearing surface between the spacer piece and the output shaft are avoided.

The connection between the spacer piece and the output shaft is also embodied advantageously as a laser weld connection. This can be realized cost effectively and can be accomplished in the same processing step as welding the crank on the output shaft.

In addition, it is particularly advantageous if the spacer piece features functional elements that seal, since this makes it possible to dispense with additional components that are required to seal the bearing.

### DRAWINGS

An exemplary embodiment of the invention is depicted in the drawings and explained in more detail in the following description. The drawings show:

FIG. 1 A schematic representation of a windshield wiper apparatus in accordance with the invention.

FIG. 2 A drive unit of a windshield wiper apparatus in accordance with the state of the art.

FIG. 3 A schematic side view of a drive unit of a windshield wiper apparatus in accordance with the invention.

FIG. 4 A section through a spacer piece of a windshield wiper apparatus in accordance with the invention.

### DESCRIPTION OF THE EXEMPLARY EMBODIMENT

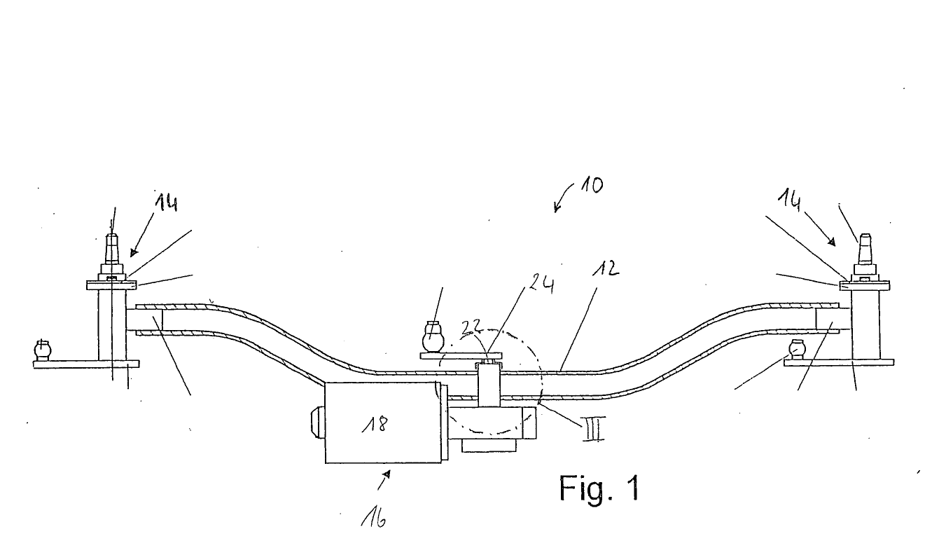

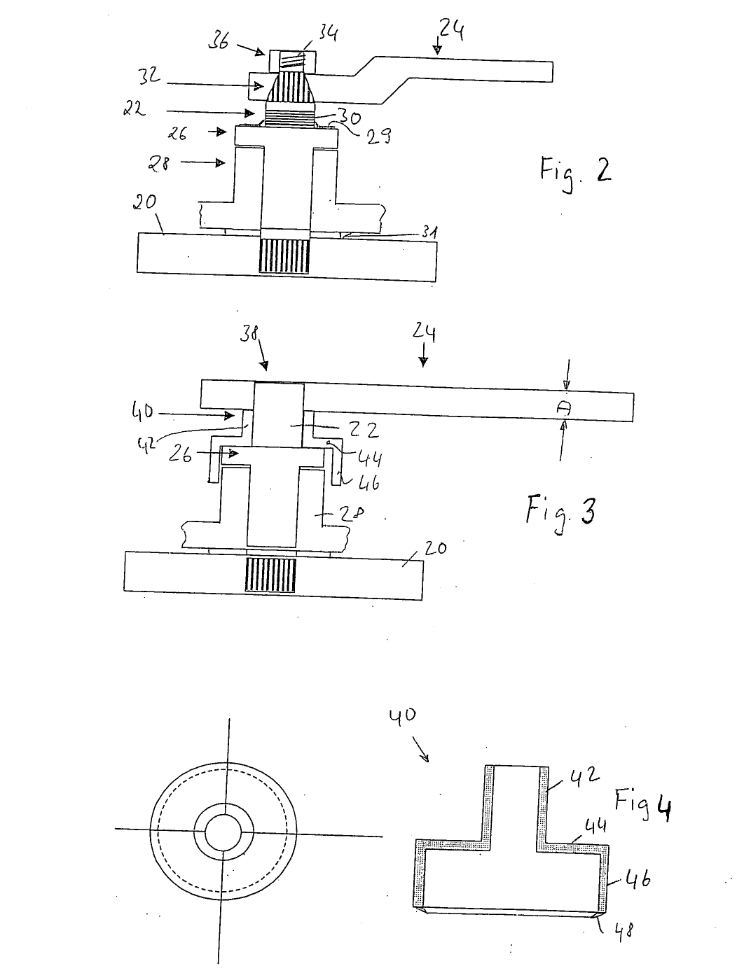

FIG. 1 shows a schematic representation of a windshield wiper apparatus 10 in accordance with the invention. It is essentially made of up a support tube 12 featuring two ends, on both of which a wiper bearing 14 is arranged. A drive unit 16 is arranged between the two wiper bearings 14 approximately in the center of the longitudinal extension of the support tube 12. The drive unit is composed essentially of an electric motor 18, whose armature shaft (not shown) features a worm, which meshes with a worm wheel 20 (FIG. 2). Sitting in the center of the worm wheel 20 is an output shaft 22, which is connected in a torque-proof manner to the worm wheel 20. One end of the output shaft 22 is connected to a crank 24 in a torque-proof manner and the crank executes a pendulum or rotating movement during operation.

FIG. 2 depicts a portion of the drive unit 16 with the crank in accordance with the state of the art. The worm wheel 20 is connected to the output shaft 22 in a torque-proof manner. The output shaft 22 is positioned in a housing 28 of the drive unit 16 by means of an eccentric bushing 26. In the area in which the output shaft 22 projects out of the eccentric bushing 26, it features a grooved area 30 onto which a speed nut 29 is slipped in order to limit the axial play. A conical area 32 attaches to the grooved area 30 and the conical area is terminated by a cylindrical threaded area 34. The crank 24 is placed on the conical area 32 of the output shaft 22 and fastened on the output shaft 22 by means of a nut 36.

FIG. 3 depicts in detail the worm wheel 20 with the output shaft 22 and the crank 24 of a windshield wiper apparatus in accordance with the invention. The output shaft 22 is connected on one of its two ends to the worm wheel 20 in a torque-proof manner. The output shaft 22 projects out of the housing 28 over a lock washer 31 and is positioned in the housing 28 via an eccentric bushing 26. The crank 24 has a cylindrical hole into which the output shaft 22 is inserted with its other end so that the plane of the crank, which is facing away from the worm wheel 20 and thus the drive unit 16, forms one plane with the end face 38 of the output shaft 22. The crank 24 is connected with output shaft 22 via a laser weld connection. A spacer piece 40 that is used to adjust the axial play of the output shaft 22 is arranged between the crank 24 and the eccentric bushing 26. Just like the crank, this spacer piece 40 is connected to the output shaft 22 in a torque-proof manner and is also connected to the output shaft 22 via a laser weld connection.

The spacer piece 40 has an essentially rotationally symmetrical shape and features three sections each having a different function.

A first section 42 is used for the actual adjustment of the distance between the crank 24 and the eccentric bushing 26. This first section 42 is also the section that is welded to the output shaft 22. Attached to this is a second shoulder section 44, which essentially has the shape of a disk and forms the bearing surface of the spacer piece 40 to the eccentric bushing 26. Attached to this shoulder section 44 is a tubular sealing section 46 whose inside diameter corresponds approximately to the outside diameter of the housing 28 and the eccentric bushing 26 in the bearing area of the output shaft 22 so that the sealing section 46 prevents dirt from penetrating into the eccentric bushing and thus into the bearing of the output shaft 22.

In one variation of the invention, it is possible for example to also attach a rubber lip to the sealing section 46 in order to further improve the sealing properties. FIG. 4 depicts a cross-section through such a spacer piece 40. The spacer piece 40 is rotationally symmetrical and features the first, tubular section 42 onto which the disk-shaped shoulder section 44 directly attaches. The tubular sealing section 46 forms a continuation of this. A sealing lip 48 is joined onto this, improving the sealing of the bearing on the housing 28. Naturally, this sealing lip 48 can also be used in the sealing section 46 via a suitable profile.

It is also possible to roll the spacer piece 40 on the output shaft instead of welding or fastening it in another manner. In principle, the spacer piece 40 must not also be connected to the output shaft 22. For example, it is possible to connect the spacer piece 40 to the housing 28, to stamp it for example, so that the tubular, first section 42 co-positions the output shaft 22. In this case, the connection between the spacer piece 40 and the housing 28, cannot be accomplished, however, until the end of assembly, since otherwise the lateral displacement of the output shaft 22 by the eccentric bushing 26 is no longer possible. However, the diameter of the tubular, first section 42 can also be selected to be correspondingly greater so that the overall adjustment range of the eccentric disk 26 can be covered.

1. Windshield wiper apparatus, in particular for a motor vehicle, with a drive unit (16) that features an output shaft (22), which is connected to a crank (24) in a torque-proof manner, characterized in that the connection of the crank (24) to the output shaft (22) is embodied as an integral connection, in particular as a laser weld connection.

2. Windshield wiper apparatus according to claim 1, characterized in that the output shaft (22) penetrates the complete thickness (D) of the crank (24) and features an end face (38), which essentially terminates flush with an outer surface of the crank (24) that faces away from the drive unit (16).

3. Windshield wiper apparatus according to one of the preceding claims, characterized in that the output shaft (22) projects out of a housing (28) and at least one spacer piece (40) is arranged between the crank (24) and the housing (28).

4. Windshield wiper apparatus according to claim 3, characterized in that the output shaft (22) is positioned on the housing (28) in a bushing (26) and the spacer piece (40) is supported on the bushing (26).

5. Windshield wiper apparatus according to claim 4, characterized in that the bushing (26) is embodied as an eccentric bushing.

6. Windshield wiper apparatus according to one of the claims 3 through 5, characterized in that the spacer piece (40) is connected to the output shaft (22) in a torque-proof manner.

7. Windshield wiper apparatus according to claim 6, characterized in that the connection between the spacer piece (40) and the output shaft (22) is embodied as a laser weld connection.

8. Windshield wiper apparatus according to one of claims 3 through 7, characterized in that the spacer piece (40) features functional elements that seal.
